(19) United States
(12) Patent Application Publication
(10) Pub. No.: US 2019/0171461 A1
(43) Pub. Date: Jun. 6, 2019

(54) SKIP AHEAD ALLOCATION AND RETIREMENT IN DYNAMIC BINARY TRANSLATION BASED OUT-OF-ORDER PROCESSORS

(71) Applicant: Intel Corporation, Santa Clara, CA (US)

(72) Inventors: Kimishkumar Patel, San Jose, CA (US); Ethan Schuchman, Santa Clara, CA (US)

(21) Appl. No.: 15/833,532

(22) Filed: Dec. 6, 2017

(51) Int. Cl. G06F 9/38

(52) U.S. Cl. CPC G06F 9/3855; G06F 9/384; G06F 9/3867; G06F 9/3887; G06F 9/3806

(57) ABSTRACT

A processor including a binary translator circuit to convert an instruction stream into an annotated instruction stream comprising an independent code tag identifying an independent code segment and a dependent code tag identifying a dependent code segment, a front end circuit to receive the annotated instruction stream in order, responsive to identifying the independent code tag in the annotated instruction stream, allocate instructions of the independent code segment associated with the independent code tag into a buffer, and responsive to identifying the dependent code tag, reserve a space for the dependent code segment associated with the dependent code tag, and an instruction execution circuit to execute the independent code segment prior to executing the dependent code segment.

### TECHNICAL FIELD

Embodiments of the disclosure relate generally to microprocessors and more specifically, but without limitation, to a dynamic binary translation based (DBT-based) microprocessor.

### BACKGROUND

Multi-core processors are found in most computing systems today, including servers, desktops and a System on a Chip (SoC). Computer systems that utilize these multi-core processors may execute instructions of various types of code.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a processing system according to an embodiment of the present disclosure.

FIG. 2 illustrates a detailed system diagram of instruction allocation according to an embodiment of the present disclosure.

FIG. 3 illustrates a detailed system diagram of instruction retirement according to an embodiment of the present disclosure.

FIG. 4 is a block diagram of a method for out-of-order execution of instructions according to an embodiment of the present disclosure.

FIG. 5A is a block diagram illustrating a micro-architecture for a processor including heterogeneous core in which one embodiment of the disclosure may be used.

FIG. 5B is a block diagram illustrating an in-order pipeline and a register renaming stage, out-of-order issue/execution pipeline implemented according to at least one embodiment of the disclosure.

FIG. 6 illustrates a block diagram of the micro-architecture for a processor that includes logic in accordance with one embodiment of the disclosure.

FIG. 7 is a block diagram illustrating a system in which an embodiment of the disclosure may be used.

FIG. 8 is a block diagram of a system in which an embodiment of the disclosure may operate.

FIG. 9 is a block diagram of a system in which an embodiment of the disclosure may operate.

FIG. 10 is a block diagram of a System-on-a-Chip (SoC) in accordance with an embodiment of the present disclosure.

FIG. 11 is a block diagram of an embodiment of an SoC design in accordance with the present disclosure.

FIG. 12 illustrates a block diagram of one embodiment of a computer system.

### DETAILED DESCRIPTION

A processor may execute a stream of instructions encoding a software application. The stream of instructions may include branches of instructions. The execution of a particular branch may depend on whether a condition is met during the execution. The condition can be a comparison between an input value and another pre-determined value. Each condition may be associated with one or more branches of instructions.

To increase the speed of instruction execution, the processor may allow out-of-order instruction execution. The processor include a branch prediction circuit that may predict which branch is most likely to be executed and cause the execution of the branch ahead of the determination of whether the condition associated with the branch has met. If the predicted condition in later actual execution of instructions turns out to be true, the performance of the processor is improved because the branch of instructions has already been executed in advance. If the predicted condition turns out to be incorrect, the state of the processor (e.g., values stored in registers of the processor) needs to be rolled back to the state prior to the branch prediction and re-execute another branch of instructions according to the actual condition value. These rollbacks are the penalty associated with branch predictions. Certain types of branches in the instruction stream are hard to predict correctly. For example, it is hard to predict the value read from memory location when the memory location may have stored any arbitrary values. When the value is used in a comparison instruction, the outcome of the comparison is also hard to predict and so are the branches that rely on the output of such comparisons. The predictions of these hard-to-predict branches in the instruction stream may cause a large performance penalty to the processor performance.

Processors may include a binary translator that may translate an original code (referred to as un-translated code) specified according to one instruction set architecture (ISA) into a target code (referred to as translated code) specified according to another ISA, where the translation may optimize the code execution. The translated code may have been optimized using certain optimization techniques. The optimization may include reordering of instructions in the translated code as compared to the original code.

Processors that are designed to execute reordered binary translation (BT) instructions are referred to as BT-based processors. BT-based processors perform speculative optimizations for power and performance gains. The binary translator associated with the BT-based processor can be a hardware component of the BT-processor or a software application executing by a processing core of the BT-based processor. In some implementations, the conversion of the original code to translated code is carried out (e.g., during code compilation) prior to loading the un-translated code for execution. This is referred to as static binary translation. Embodiments of the present disclosure utilize dynamic binary translation, where the un-translated code is converted to the translated code based on whether certain conditions are met during the execution process rather than during the code compilation process.

Embodiments of the present disclosure provide a technical solution that allows for out-of-order instruction execution without employing branch prediction. Instead of employing the branch prediction circuit to predict certain values (and thus which branch of instructions to execute in advance), embodiments of the disclosure use the binary translator of a dynamic binary translation based processor to convert the stream of instructions into independent code segments (tagged by independent code tags) and dependent code segments (tagged by dependent code tags). The independent code segments contain instructions that are executed sequentially without dependency on condition they are responsible of producing; the dependent code segments contain instructions, the execution of which depends on a value calculated in an independent code segment. Embodiments of the present disclosure include circuit components and associated methods to ensure that the independent code segments are executed prior to execution of the dependent code segments. This ensures that the instructions, which are responsible of producing result value upon which a dependent code segment relies, are already past the rename/allocation stage of the processor at the time to rename/allocate the dependent code segment, thus eliminating the risk of mis-predicting the execution of the dependent code segment. The elimination of the rollbacks associated with mis-predictions improves the performance of the processor.

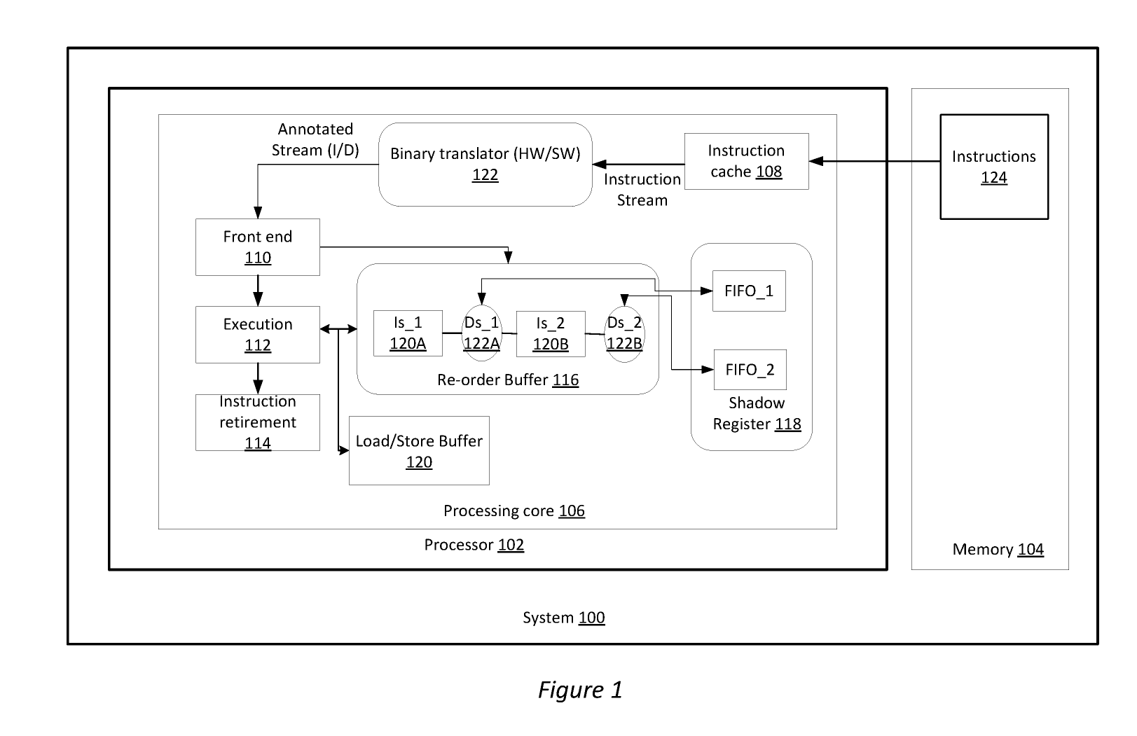

FIG. 1 illustrates a processing system 100 according to an embodiment of the present disclosure. As shown in FIG. 1, processing system 100 (e.g., a system-on-a-chip (SOC) or a motherboard of a computer system) may include a processor 102 and a memory device 104 communicatively coupled to processor 102. Processor 102 may be a hardware processing device such as, for example, a central processing unit (CPU) or a graphic processing unit (GPU) that includes one or more processing cores to execute software applications.

Processor 102 may further include processing core 106 which, in various implementations, may be capable of in-order cores or out-of-order execution of instructions. In an illustrative example, processing core 106 may have a micro-architecture including processor logic and circuits used to implement an instruction set architecture (ISA). Processors 102 with different micro-architectures can share at least a portion of a common instruction set. For example, the same register architecture of the ISA may be implemented in different ways in different micro-architectures using various techniques, including dedicated physical registers, one or more dynamically allocated physical registers using a register renaming mechanism (e.g., the use of a register alias table (RAT), or a re-order buffer (ROB) and a retirement register file).

Referring to FIG. 1, processing core 106 may further include an instruction cache 108, a front end circuit 110, an execution circuit 112, and an instruction retirement circuit 114. Processing core 106 may also include a register file including a re-order buffer (ROB) 116, and a load/store buffer 120, and a shadow register file 118 implementing a first-in-first-out (FIFO) queues. Processing core 106 may further include a binary translator 122 for re-ordering original code into a target code that may be executed speculatively in an Out-of-Order (OoO) fashion. In one embodiment, binary translator 122 may be implemented in logic circuit as a hardware component of processing core 106. In another embodiment, binary translator 122 may be implemented as a software application running on processing core 106.

Instruction cache circuit 108 may receive instructions from a memory area 124 using an instruction fetch circuit (not shown) and store instructions retrieved in a cache memory 108 of processing core 106. The retrieved instructions can be in a sequence (referred to as a stream of instructions) that can be executed in order. In one embodiment, binary translator 122 may receive the stream of instructions from instruction cache circuit 108 and perform code optimization by re-ordering instructions in the code to generate a target code.

The stream of instructions received by binary translator 122 can be original code (un-translated code). In one embodiment, binary translator 122 may include the functionality to identify independent code segments and dependent code segments, and annotate them correspondingly. Responsive to receiving the stream of instructions, binary translator 122 may group the instruction stream into independent code segments (tagged by independent code tags) and dependent code segments (tagged by dependent code tags). The independent code segments contain instructions that are executed sequentially without dependency on a condition; the dependent code segments contain instructions the execution of which depends on a result value calculated in an independent code segment. Table 1 illustrates an example code that can be grouped into independent code segments and dependent code segments.

TABLE 1

| | |
|---|---|
| 1. | foreach rowId in input // an array or a bit array |
| 2. | { |

| | |
|---|---|
| 3. | valueId = data_chunk.get(rowId); |
| 4. | // read or decompress (6 types) |
| 5. | if(predicate(valueId)) |
| 6. | // e.g. range check, set check, etc. |
| 7. | { |

| | |
|---|---|
| 8. | write rowId; |
| 9. | /* set rowId bit in the output bit array |
| 10. | or (in-place to input) array */ |
| 11. | } |

| | |
|---|---|
| 12. | } |

The stream of instructions in Table 1 includes a conditional instruction of predicate (valueId) at line 5. The conditional instruction is an instruction that generates a condition value, where the condition value may determine the execution of a dependent code segment. The value of valueId (received at valueId=data_chunk.genrowId) at line 3) determines whether the branch code (lines 7-11) will be executed. Some implementations may use a branch prediction circuit to predict the value of valueId and perform out-or-order execution of the branch code. When the value of valueId is hard to predict, mis-predictions may occur frequently and cause rollback of register states including the rollback of the register that stores valueId. Embodiments of the present disclosure may include binary translator 122 that may identify independent code segments and dependent code segments in the stream of instructions and may convert the stream of instructions into an annotated stream of instructions including corresponding tags to identify these code segments. For the stream of instructions as shown in Table 1, the independent code tags (e.g., “independent_code_segment_begin” and “independent_code_segment_end”) in the annotated code may mark the independent code segment (from line 2 to line 5); the dependent code tags (e.g., “dependent_code_segment_begin” and “dependent_code_segment_end”) in the annotated code may mark the dependent code segment (from line 6 to line 11 because the execution of write rowID depends on valueId). The annotated stream of instructions may be provided to front end circuit 110 for instruction allocation.

The example code of Table 1 includes one layer of dependent code segment. In other embodiments, a dependent code segment may include a further conditional instruction in the dependent code segment. Similar to above definition, the conditional instruction is an instruction that generates a condition value, where the condition value may determine the execution of a dependent code segment. The condition value in the dependent code segment may determine the execution of a further dependent code segment code. Thus, the dependent code segment can depend on a conditional instruction in another dependent code segment which may further depend on a conditional instruction in an independent code segment, thus forming nested dependencies. Because of the nested dependency determines whether and which instructions in the dependent code segments are executed, the total number of instructions eventually executed by processing core 106 may vary. Embodiments of the present disclosure refer the maximum possible number of executable instructions of a dependent code segment (i.e., the number of instructions executed when all conditions of the dependent code segment are met) as the maximum length of the dependent code segment.

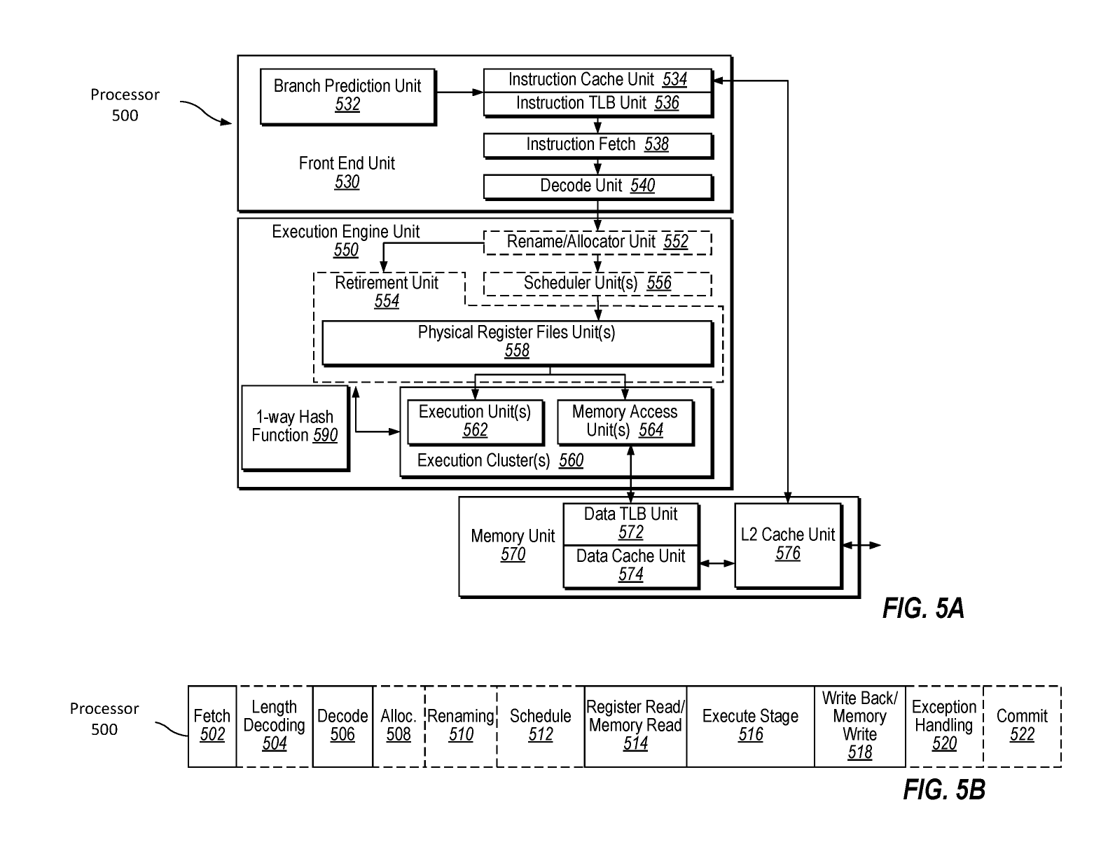

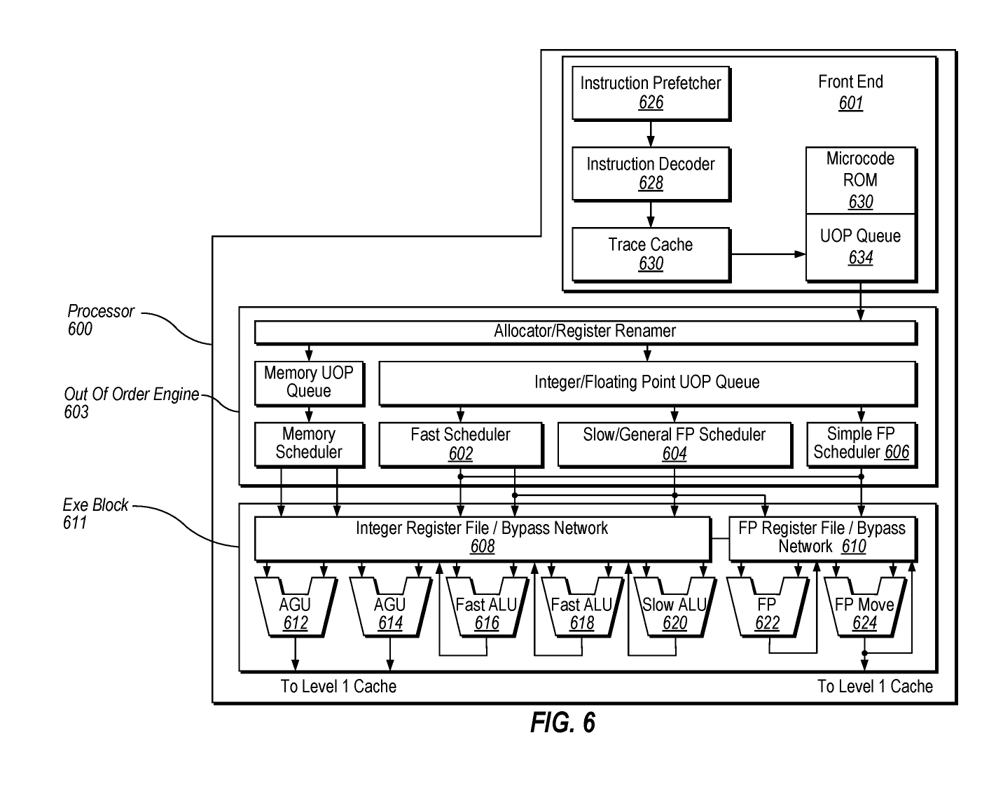

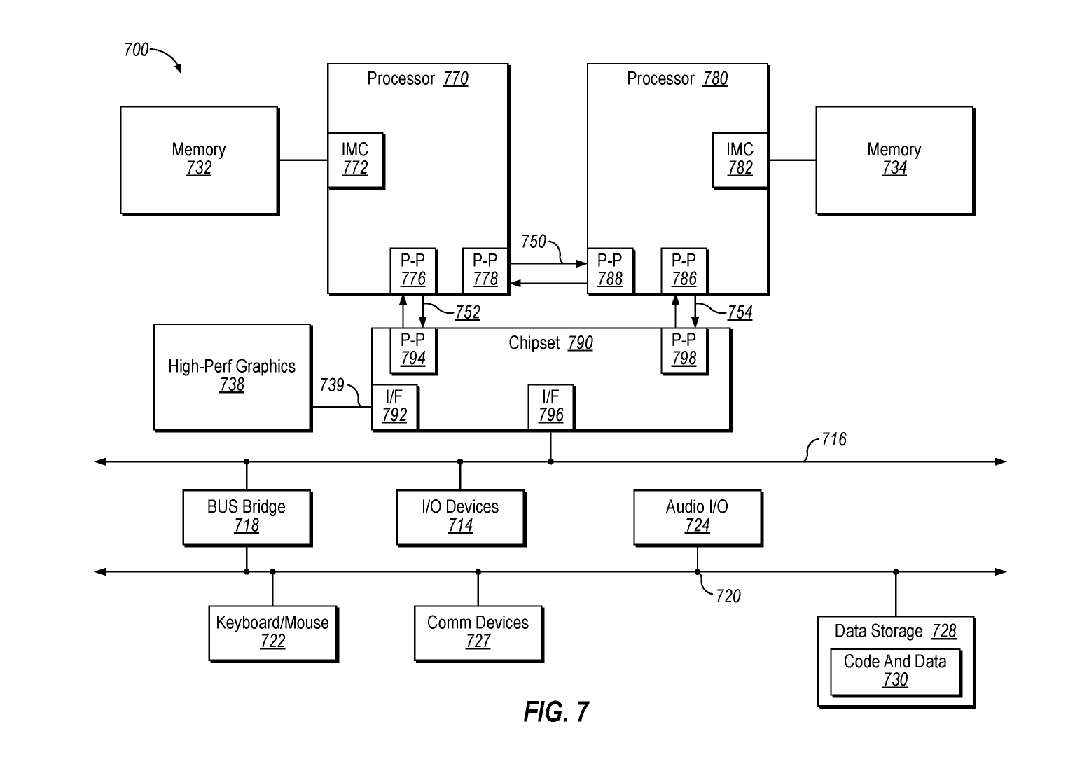

Front end circuit 110 may receive the annotated stream of instructions from binary translator 122 and allocate buffers (including re-order buffer 116, and load/store buffer 120) for these instructions based on the annotations prior to the execution of these instructions. An exemplary architecture of front end circuit 110 is shown in FIG. 5A as front end unit 530 and in FIG. 6 as front end 601. Binary translator 122 may be implemented as a binary translation circuit as part of processor 770, 780 as shown in FIG. 7 or as a software application programmed to executed by processor 770, 780. Binary translator 112 may analyze control and data flow of the input stream of instructions. In one example, binary translator 122 may model instructions as nodes in a directed acyclic graph where edges between nodes may model control and/or data dependency. On such a graph, binary translator 122 may form clusters of nodes where there are no control dependent edges between the nodes of the cluster. In such clusters, binary translator 122 can annotate those clusters that have no direct or indirect control dependency on other clusters as independent cluster and those with such dependency as dependent clusters. Clusters, with a number of instructions, are tagged with appropriate dependency information to identify if they are independent clusters or not and if they are dependent, which cluster they have dependency on. Re-order buffer 116 is a temporary storage (e.g., registers or a region of memory) that can include a list of positions to place the stream of instructions back in order after the out-of-order execution of these instructions. Load/store buffer 120 is a temporary storage for storing state values of memory 104 during the out-of-order execution. The following description is provided in the context of re-order buffer 116. It is understood that the mechanism to allocate and retire re-order buffer 116 is similarly applicable to allocation of load/store buffer 120.

Front end circuit 110 may fetch, allocate, and execute independent code segments and dependent code segment separately, and may allow in-order retirement according to the order of the original stream of instructions. In one embodiment, front end circuit 110 may fetch, allocate, and execute an independent code segment prior to a dependent code segment that depends on the independent code segment. Thus, the execution of the dependent code segment may be performed after the completion of the execution of the independent code segment, thus avoiding branch prediction. In this way, processing core 106 may perform out-of-order instruction execution without making mis-prediction of branches.

In one embodiment, the instructions in the annotated stream may include one or more micro-operations, micro-code entry points, microinstructions, other instructions, or other control signals (collectively referred to as “micro-operations”), which are decoded from, or which otherwise reflect, or are derived from, the original instructions. Front end circuit 110 may allocate a micro-operation into re-order buffer 116 based on whether the micro-operation belongs to an independent code segment or a dependent code segment. In one embodiment, an annotated stream of instructions (or micro-operations) may include independent code segments (e.g., Ls_1, Ls_2) and dependent code segments (Ds_1, Ds_2). Responsive to identifying an independent code segment (e.g., by identifying “independent_code_segment_begin” tag) in the annotated stream, front end circuit 110 may fetch micro-operations in the independent code segment and sequentially allocate these micro-operations in segments 120A, 120B of re-order buffer 116. Responsive to identifying a dependent code segment (e.g., by identifying “dependent_code_segment_begin” tag) in the annotated stream, front end circuit 110 may skip the allocation of the micro-operations in the dependent code segment by reserving, without allocating, a space (122A, 122B) corresponding to the maximum length of the dependent code segments in the re-order buffer. The allocation of the micro-operations in the dependent code segments occurs after the execution of the instructions in the independent code segment which results in the resolution of the condition values the dependent code segments depend on. In this way, embodiments of the present disclosure may avoid rollbacks caused by branch mis-predictions.

In one embodiment, the re-order buffer 116 may be implemented as a circular buffer including a head pointer and a tail pointer. At the initial stage, when the re-order buffer 116 is empty without any micro-operation allocated in it, the head pointer and tail pointer may both point to a same starting location. Responsive to fetching a micro-operation belonging to an independent code segment, front end circuit 110 may allocate the micro-operation into re-order buffer 116 and cause the head pointer to increment by one position. Responsive to identifying a dependent code segment (e.g., by identifying the “dependent_code_segment_begin” tag), front end circuit 110 may first determine the maximum length of the dependent code segment (e.g., by counting the number of micro-operations that will be executed within the dependent code segment, assuming that all conditions within the dependent code segment are met), and then skip the maximum length of positions in re-order buffer 116 before processing the next micro-operation in the annotated stream. The head pointer may correspondingly skip a space (a number of positions in the list of the re-order buffer that matches the maximum length) to point to the position following the space reserved for the dependent code segment.

The processing core 106 may further include a shadow register file 118 for storing the starting position of the space reserved for the dependent code segment. In one embodiment, shadow register file 118 may include registers to implement first-in-first-out queues (FIFO_1, FIFO_2) used for storing branching points indicating the transitions from an independent code segment to a dependent code segment. Each dependent code segment may be assigned to one or more FIFOs. Responsive to identifying a tag in the annotated stream indicating an independent code segment end, front end circuit 110 may store the position value of the last micro-operation in the independent code segment in a FIFO.

Processing core 106 may further include an instruction execution circuit 112 that may execute the allocated micro-operations of the independent code segment ahead of the allocation and execution of the micro-operations of the dependent code segment. After instruction execution circuit 112 executes instructions in the independent code segment and thus determines the condition value upon which the dependent code segment depends, front end circuit 110 may retrieve the position value stored in the FIFO. The position value may serve as the starting point for allocating micro-operations of the dependent code segment into the re-order buffer. From the position, front end circuit 110 may start allocating the micro-operations of the dependent code segment into the space designated for the dependent code segment. The number of micro-operations allocated into the space varies depending on the conditional value but does not exceed the full length of the space. Instruction execution circuit 112 may then proceed to execute the micro-operations of the dependent code segment.

Processing core 106 may further include an instruction retirement circuit 114 to reclaim physical registers used by instructions that are done for execution. The retirement of physical registers makes these registers available for other instructions. In one one embodiment, the instruction retirement is performed in the order of the original stream of instructions. The in-order retirement of instructions is achieved by sequentially retiring micro-operations of the independent code segment allocated in re-order buffer 116. The micro-operations of the dependent code segment allocated in re-order buffer 116 may only partially fill the space assigned to the dependent code segment because some conditions are not met. Embodiments may provide a retirement FIFO to the dependent code segment to store the starting position value of the next independent code segment following the dependent code segment. After retiring the last micro-operation of the dependent code segment, instruction retirement circuit 114 may retrieve the starting position value stored in the retirement FIFO and continue to retire instruction from the starting position value of re-order buffer 116.

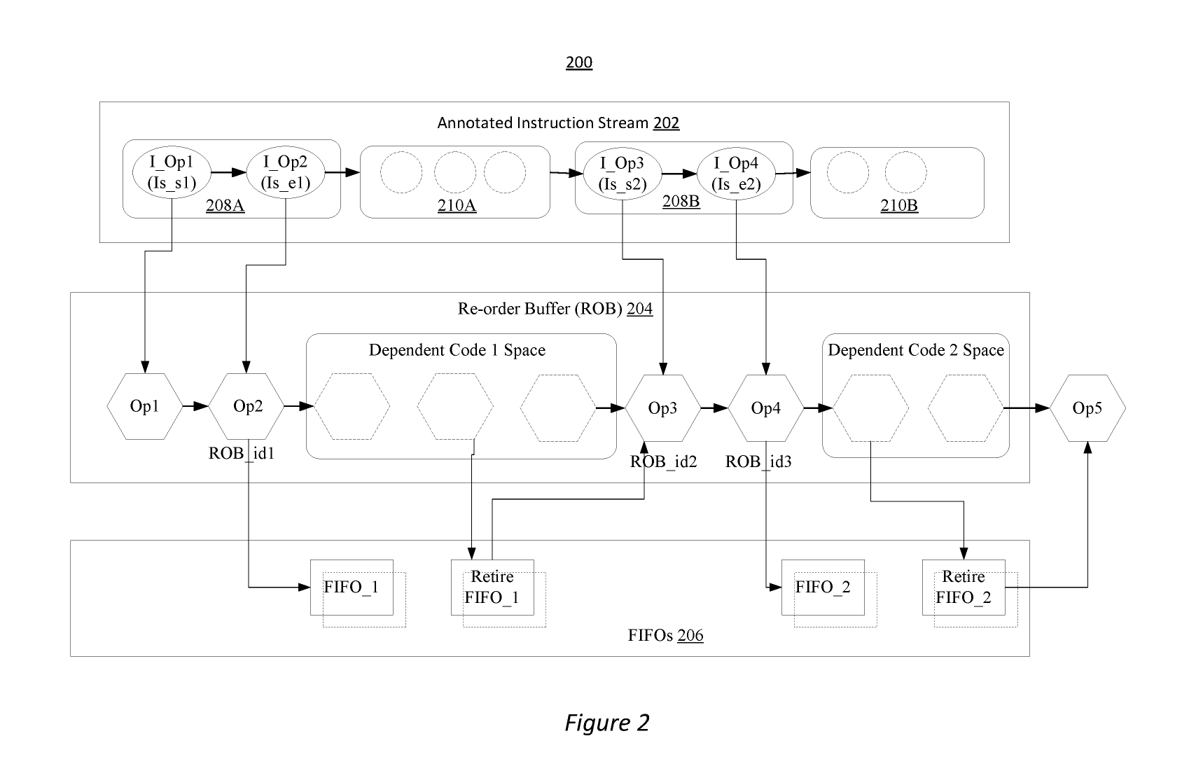

FIG. 2 illustrates a detailed system diagram 200 of instruction allocation according to an embodiment of the present disclosure. System 200 may include a front end circuit to receive an annotated stream of instructions 202 and allocate these instructions into a re-order buffer 204. System 200 may also include a shadow register file to implement first-in-first-out queues (FIFOs) for storing branch points that can be used for allocating and retiring micro-operations of dependent code segments. In one embodiment, as shown in FIG. 2, annotated stream 200 may include independent code segments 208A, 208B, and dependent code segments 210A, 210B. The original order of instructions is to execute micro-operations of independent code segment 208A, dependent code segment 210A, independent code segment 208B, and then dependent code segment 210B. Annotated stream 202 may include tags to identify the start and end of independent code segments and similarly, tags to to identify the start and end of dependent code segments. For example, the start of independent code segment 208A (or 208B) may be identified by a tag associated with instruction I_Op1 (or I_Op3); the end of of independent code segment 208A (or 208B) may be identified by a tag associated with instruction I_Op2 (or I_Op4).

Upon fetching annotated stream 202, the front end circuit may allocate micro-operations of annotated stream 202 into re-order buffer (ROB) 204 to prepare for out-of-order execution. Front end circuit may first identify, based on the tags in annotated stream 202, the start and end of independent code segments 208A, 208B. The front end circuit may identify micro-operations of independent code segments 208A, 208B and sequentially allocate them in re-order buffer 204. For example, responsive to identifying the tag (Is_s1) indicating the start of independent code segment 208A, the front end circuit may sequentially allocate micro-operations of independent code segment 208A into re-order buffer 204 (e.g., I_Op1 to Op1, . . . , I_Op2 to Op2). Responsive to identifying the tag (Is_e1) indicating the end of independent code segment 208A, the front end circuit may store the position value (ROB_id1) of the last allocated micro-operation (Op2) in FIFO_1 to preserve the branch point for dependent code segment 210A.

The front end circuit may further determine the maximum length of dependent code segment 210A, and skip the maximum length (e.g., three positions) in re-order buffer 204 and move the head pointer to the position following the space reserved for dependent code segment 210A. Correspondingly, the front end circuit may identify the start and end of the next independent code segment 208B, and sequentially allocate micro-operations of independent code segment 208B into re-order buffer starting from position ROB_id2. The sequential allocation of micro-operations of independent code segment 208B continues until the front end circuit identifies the tag indicating the end (ROB_id3) of independent code segment 208B. Responsive to identifying the end of independent code segment 208B, the front end circuit may store the end position (ROB_id3) in FIFO_2, where FIFO_2 is associated with dependent code segment 210B. The front end circuit may then leave a space matching the maximum length of dependent code segment 210B in re-order buffer 204.

Responsive to allocating the micro-operations of independent code segments 208A, 208B, the instruction execution circuit may start the execution of these micro-operations prior to allocating and executing micro-operations of dependent code segments 210A, 210B. The execution of micro-operations of independent code segments 208A, 208B may resolve the condition values upon which the execution of dependent code segments 210A, 210B depend. Responsive to resolving the condition values dependent code segments 210A, 210B depend on, the front end circuit may, based on the condition values, allocate micro-operations of dependent code segments 210A, 210B. Depending on the condition values calculated from independent code segments 208A, 208B, the front end circuit may allocate a subset of micro-operations of dependent code segments 210A, 210B. Under this scenario, the front end circuit may also store the position value following dependent code segments 210A, 210B in retirement FIFOs (e.g., retire FIFO_1, retire FIFO_2). The positions stored in retirement FIFOs can be used in in-order instruction retirement.

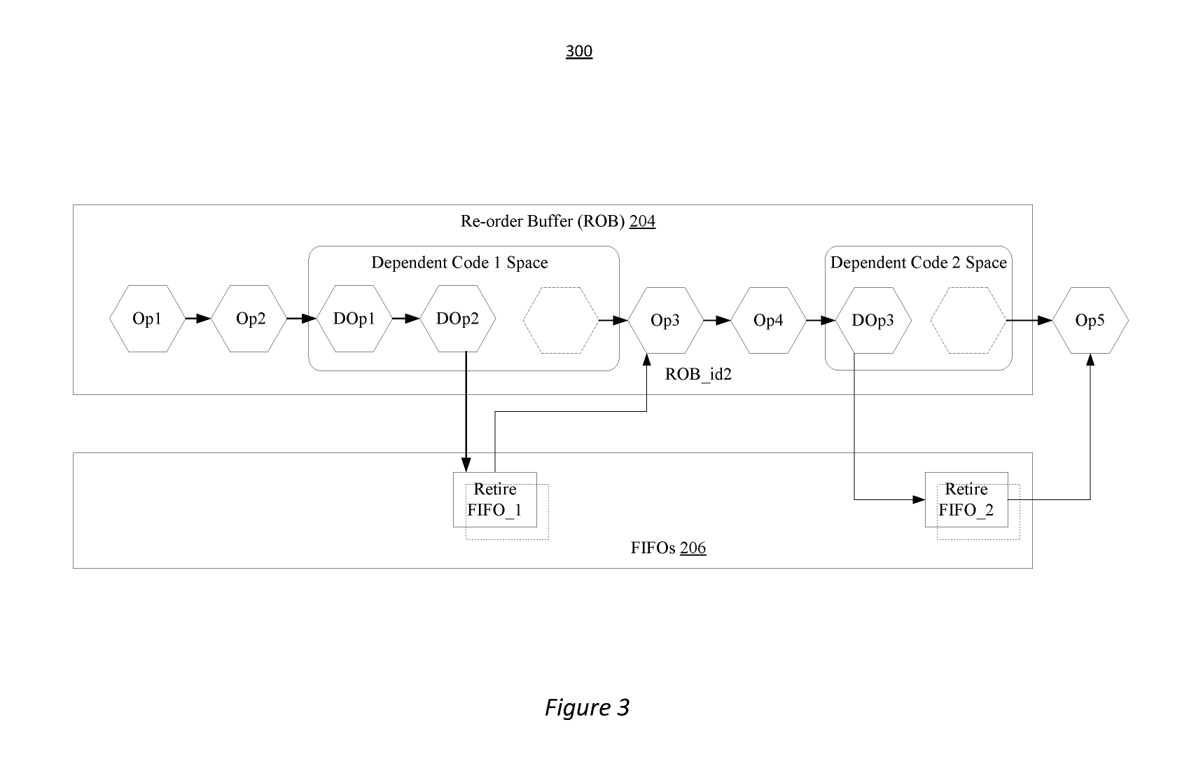

FIG. 3 illustrates a detailed system diagram 300 of instruction retirement according to an embodiment of the present disclosure. Instruction retirement circuit 114 (as shown in FIG. 1) may retire instructions that are allocated in the re-order buffer. The instruction retirement may be in the order of the original stream of instructions. Responsive to the instruction execution circuit has completed the execution of both independent code segments and dependent code segments, the instruction retirement circuit may retire instructions in the order of the original stream. As shown in FIG. 3, the instruction retirement circuit first may first retire physical registers associated with micro-operations (Op1, Op2) of independent code segment 208A. For dependent code segment 210A, the instruction retirement circuit may retire physical registers associated with micro-operations of dependent code segment 210A until reaching the end of allocated micro-operator (DOp2). The end of allocated micro-operator (DOp2) can be different from the last position in the space reserved for the dependent code segment because certain condition values generated by independent code segment 208A prevent some micro-operations of dependent code segment 210A from allocating into re-order buffer 204. Responsive to reaching the last allocated position in the space reserved for the dependent code segment 210A, the instruction retirement circuit may retrieve from retirement FIFO_1 to receive the position value for the next micro-operation (Op3) to retire. The instruction retirement circuit may then proceed to retire the physical registers associated with the next micro-operation (Op3) of independent code segment 208B. This process may repeat until the instruction retirement circuit retires all micro-operators that need to retire in re-order buffer 204.

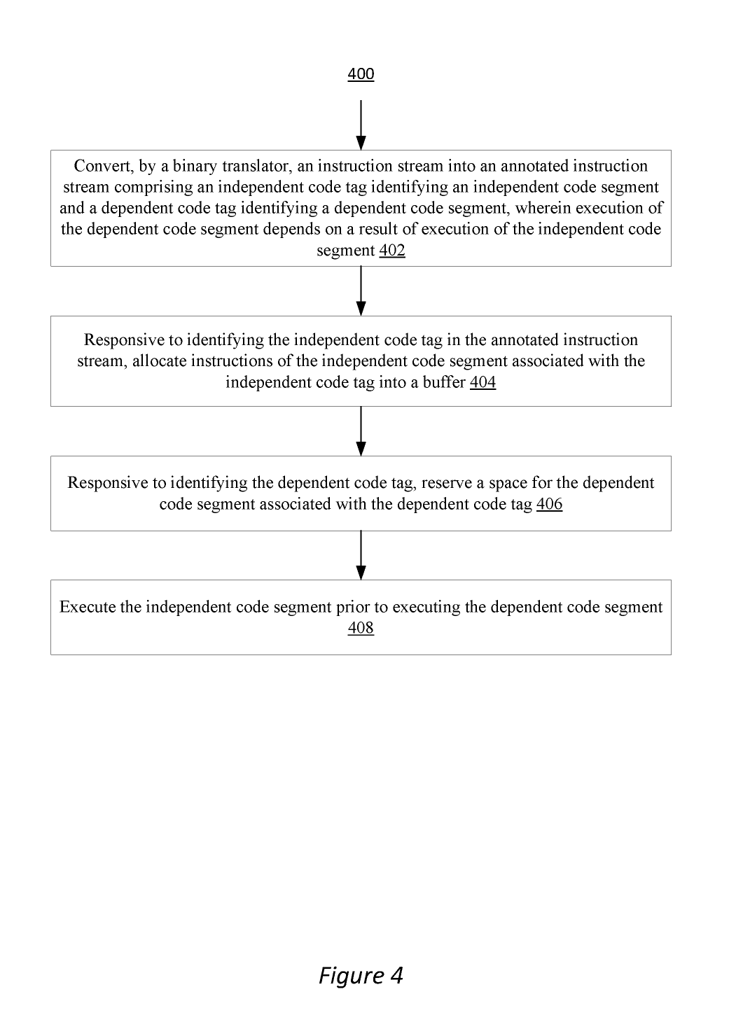

FIG. 4 is a block diagram of a method 400 for out-of-order execution of instructions according to an embodiment of the present disclosure. Method 400 may be performed by processing logic that may include hardware (e.g., circuitry, dedicated logic, programmable logic, microcode, etc.), software (such as instructions run on a processing device, a general purpose computer system, or a dedicated machine), firmware, or a combination thereof. In one embodiment, method 400 may be performed, in part, by processor 102 and processing core 106, as shown in FIG. 1.

For simplicity of explanation, the method 400 is depicted and described as a series of acts. However, acts in accordance with this disclosure can occur in various orders and/or concurrently and with other acts not presented and described herein. Furthermore, not all illustrated acts may be performed to implement the method 400 in accordance with the disclosed subject matter. In addition, those skilled in the art will understand and appreciate that the method 400 could alternatively be represented as a series of interrelated states via a state diagram or events.

Referring to FIG. 4, the processor executing a binary translator, at 402, may convert an instruction stream into an annotated instruction stream comprising an independent code tag identifying an independent code segment and a dependent code tag identifying a dependent code segment, wherein execution of the dependent code segment depends on a result of execution of the independent code segment.

At 404, responsive to identifying the independent code tag in the annotated instruction stream, the processor may allocate instructions of the independent code segment associated with the first independent code tag into a buffer.

At 406, responsive to identifying the dependent code tag, the processor may reserve a space for the dependent code segment associated with the first dependent code tag.

At 408, the processor may execute the independent code segment prior to executing the dependent code segment.

FIG. 5A is a block diagram illustrating a micro-architecture for a processor 500 that implements the processing device including heterogeneous cores in accordance with one embodiment of the disclosure. Specifically, processor 500 depicts an in-order architecture core and a register renaming logic, out-of-order issue/execution logic to be included in a processor according to at least one embodiment of the disclosure.

Processor 500 includes a front end unit 530 coupled to an execution engine unit 550, and both are coupled to a memory unit 570. The processor 500 may include a reduced instruction set computing (RISC) core, a complex instruction set computing (CISC) core, a very long instruction word (VLIW) core, or a hybrid or alternative core type. As yet another option, processor 500 may include a special-purpose core, such as, for example, a network or communication core, compression engine, graphics core, or the like. In one embodiment, processor 500 may be a multi-core processor or may part of a multi-processor system.

The front end unit 530 includes a branch prediction unit 532 coupled to an instruction cache unit 534, which is coupled to an instruction translation lookaside buffer (TLB) 536, which is coupled to an instruction fetch unit 538, which is coupled to a decode unit 540. The decode unit 540 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 540 may be implemented using various different mechanisms. Examples of suitable mechanisms include, but are not limited to, look-up tables, hardware implementations, programmable logic arrays (PLAs), microcode read only memories (ROMs), etc. The instruction cache unit 534 is further coupled to the memory unit 570. The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations (RS), central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 558 is overlapped by the retirement unit 554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

In one implementation, processor 500 may be the same as processor 102 described with respect to FIG. 1. In particular, processor 500 may include processing core 106 as shown in FIG. 1.

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which may include a data prefetcher 580, a data TLB unit 572, a data cache unit (DCU) 574, and a level 2 (L2) cache unit 576, to name a few examples. In some embodiments DCU 574 is also known as a first level data cache (L1 cache). The DCU 574 may handle multiple outstanding cache misses and continue to service incoming stores and loads. It also supports maintaining cache coherency. The data TLB unit 572 is a cache used to improve virtual address translation speed by mapping virtual and physical address spaces. In one exemplary embodiment, the memory access units 564 may include a load unit, a store address unit, and a store data unit, each of which is coupled to the data TLB unit 572 in the memory unit 570. The L2 cache unit 576 may be coupled to one or more other levels of cache and eventually to a main memory.

In one embodiment, the data prefetcher 580 speculatively loads/prefetches data to the DCU 574 by automatically predicting which data a program is about to consume. Prefeteching may refer to transferring data stored in one memory location of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 500 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5B is a block diagram illustrating an in-order pipeline and a register renaming stage, out-of-order issue/execution pipeline implemented by processor 500 of FIG. 5A according to some embodiments of the disclosure. The solid lined boxes in FIG. 5B illustrate an in-order pipeline, while the dashed lined boxes illustrates a register renaming, out-of-order issue/execution pipeline. In FIG. 5B, a processor 500 as a pipeline includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524. In some embodiments, the ordering of stages 502-524 may be different than illustrated and are not limited to the specific ordering shown in FIG. 5B.

FIG. 6 illustrates a block diagram of the micro-architecture for a processor 600 that includes hybrid cores in accordance with one embodiment of the disclosure. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 601 is the part of the processor 600 that fetches instructions to be executed and prepares them to be used later in the processor pipeline.

The front end 601 may include several units. In one embodiment, the instruction prefetcher 626 fetches instructions from memory and feeds them to an instruction decoder 628 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one embodiment, if more than four micro-ops are needed to complete an instruction, the decoder 628 accesses the microcode ROM 632 to do the instruction. For one embodiment, an instruction can be decoded into a small number of micro ops for processing at the instruction decoder 628. In another embodiment, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one embodiment from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one embodiment can schedule on each half of the main clock cycle while the other schedulers can only schedule once per main processor clock cycle. The schedulers arbitrate for the dispatch ports to schedule uops for execution.

Register files 608, 610, sit between the schedulers 602, 604, 606, and the execution units 612, 614, 616, 618, 620, 622, 624 in the execution block 611. There is a separate register file 608, 610, for integer and floating point operations, respectively. Each register file 608, 610, of one embodiment also includes a bypass network that can bypass or forward just completed results that have not yet been written into the register file to new dependent uops. The integer register file 608 and the floating point register file 610 are also capable of communicating data with the other. For one embodiment, the integer register file 608 is split into two separate register files, one register file for the low order 32 bits of data and a second register file for the high order 32 bits of data. The floating point register file 610 of one embodiment has 128 bit wide entries because floating point instructions typically have operands from 64 to 128 bits in width.

The execution block 611 contains the execution units 612, 614, 616, 618, 620, 622, 624, where the instructions are actually executed. This section includes the register files 608, 610, that store the integer and floating point data operand values that the micro-instructions need to execute. The processor 600 of one embodiment is comprised of a number of execution units: address generation unit (AGU) 612, AGU 614, fast ALU 616, fast ALU 618, slow ALU 620, floating point ALU 622, floating point move unit 624. For one embodiment, the floating point execution blocks 622, 624, execute floating point, MMX, SIMD, and SSE, or other operations. The floating point ALU 622 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 616, 618. The fast ALUs 616, 618, of one embodiment can execute fast operations with an effective latency of half a clock cycle. For one embodiment, most complex integer operations go to the slow ALU 620 as the slow ALU 620 includes integer execution hardware for long latency type of operations, such as a multiplier, shifts, flag logic, and branch processing. Memory load/store operations are executed by the AGUs 612, 614. For one embodiment, the integer ALUs 616, 618, 620, are described in the context of performing integer operations on 64 bit data operands. In alternative embodiments, the ALUs 616, 618, 620, can be implemented to support a variety of data bits including 16, 32, 128, 256, etc. Similarly, the floating point units 622, 624, can be implemented to support a range of operands having bits of various widths. For one embodiment, the floating point units 622, 624, can operate on 128 bits wide packed data operands in conjunction with SIMD and multimedia instructions.

In one embodiment, the uops schedulers 602, 604, 606, dispatch dependent operations before the parent load has finished executing. As uops are speculatively scheduled and executed in processor 600, the processor 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The processor 600 also includes logic to implement store address prediction for memory disambiguation according to embodiments of the disclosure. In one embodiment, the execution block 611 of processor 600 may include a store address predictor (not shown) for implementing store address prediction for memory disambiguation.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions below, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

Referring now to FIG. 7, shown is a block diagram illustrating a system 700 in which an embodiment of the disclosure may be used. As shown in FIG. 7, multiprocessor system 700 is a point-to-point interconnect system, and includes a first processor 770 and a second processor 780 coupled via a point-to-point interconnect 750. While shown with only two processors 770, 780, it is to be understood that the scope of embodiments of the disclosure is not so limited. In other embodiments, one or more additional processors may be present in a given processor. In one embodiment, the multiprocessor system 700 may implement hybrid cores as described herein.

Processors 770 and 780 are shown including integrated memory controller units 772 and 782, respectively. Processor 770 also includes as part of its bus controller units point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

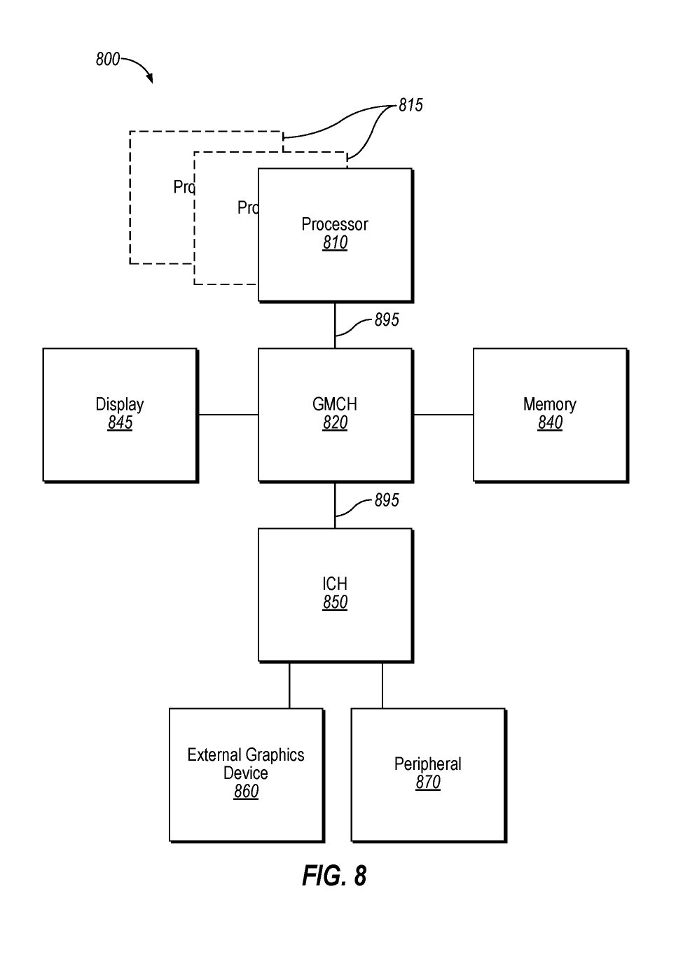

Referring now to FIG. 8, shown is a block diagram of a system 800 in which one embodiment of the disclosure may operate. The system 800 may include one or more processors 810, 815, which are coupled to graphics memory controller hub (GMCH) 820. The optional nature of additional processors 815 is denoted in FIG. 8 with broken lines. In one embodiment, processors 810, 815 implement hybrid cores according to embodiments of the disclosure.

Each processor 810, 815 may be some version of the circuit, integrated circuit, processor, and/or silicon integrated circuit as described above. However, it should be noted that it is unlikely that integrated graphics logic and integrated memory control units would exist in the processors 810, 815. FIG. 8 illustrates that the GMCH 820 may be coupled to a memory 840 that may be, for example, a dynamic random access memory (DRAM). The DRAM may, for at least one embodiment, be associated with a non-volatile cache.

The GMCH 820 may be a chipset, or a portion of a chipset. The GMCH 820 may communicate with the processor(s) 810, 815 and control interaction between the processor(s) 810, 815 and memory 840. The GMCH 820 may also act as an accelerated bus interface between the processor(s) 810, 815 and other elements of the system 800. For at least one embodiment, the GMCH 820 communicates with the processor(s) 810, 815 via a multi-drop bus, such as a frontside bus (FSB) 895.

Furthermore, GMCH 820 is coupled to a display 845 (such as a flat panel or touchscreen display). GMCH 820 may include an integrated graphics accelerator. GMCH 820 is further coupled to an input/output (I/O) controller hub (ICH) 850, which may be used to couple various peripheral devices to system 800. Shown for example in the embodiment of FIG. 8 is an external graphics device 860, which may be a discrete graphics device, coupled to ICH 850, along with another peripheral device 870.

Alternatively, additional or different processors may also be present in the system 800. For example, additional processor(s) 815 may include additional processors(s) that are the same as processor 810, additional processor(s) that are heterogeneous or asymmetric to processor 810, accelerators (such as, e.g., graphics accelerators or digital signal processing (DSP) units), field programmable gate arrays, or any other processor. There can be a variety of differences between the processor(s) 810, 815 in terms of a spectrum of metrics of merit including architectural, micro-architectural, thermal, power consumption characteristics, and the like. These differences may effectively manifest themselves as asymmetry and heterogeneity amongst the processors 810, 815. For at least one embodiment, the various processors 810, 815 may reside in the same die package.

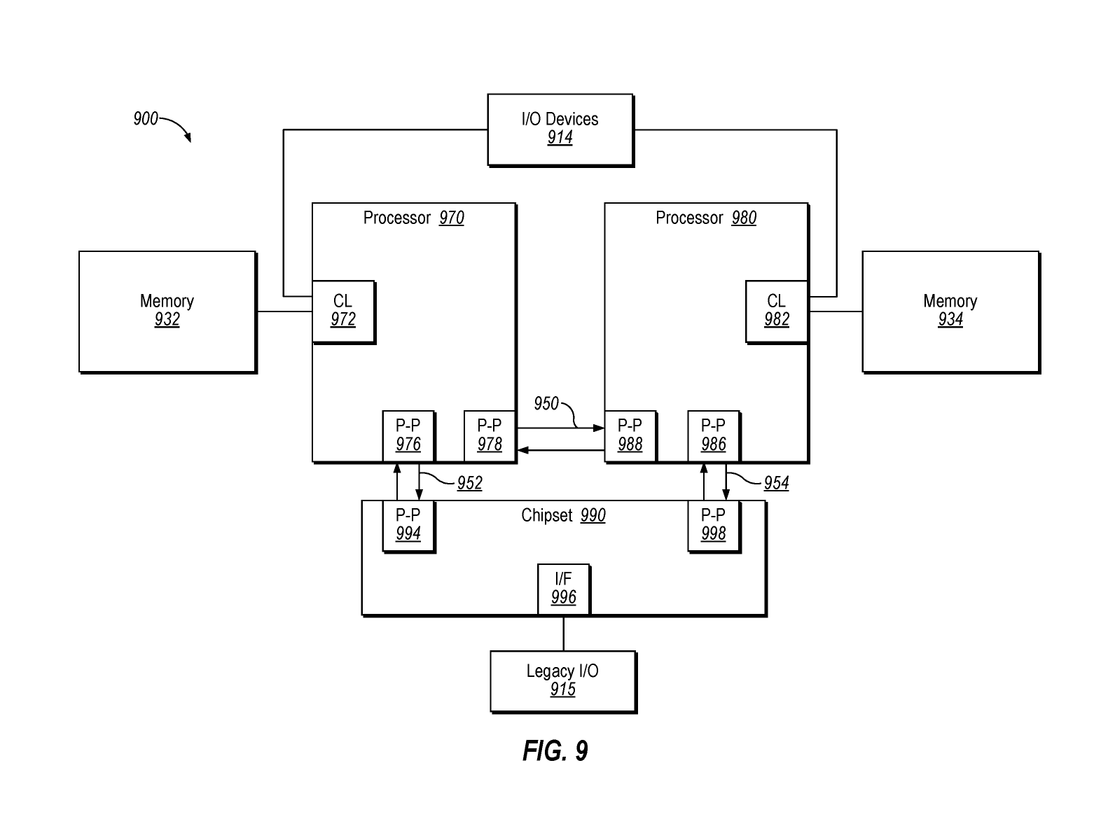

Referring now to FIG. 9, shown is a block diagram of a system 900 in which an embodiment of the disclosure may operate. FIG. 9 illustrates processors 970, 980. In one embodiment, processors 970, 980 may implement hybrid cores as described above. Processors 970, 980 may include integrated memory and I/O control logic (“CL”) 972 and 982, respectively and intercommunicate with each other via point-to-point interconnect 950 between point-to-point (P-P) interfaces 978 and 988 respectively. Processors 970, 980 each communicate with chipset 990 via point-to-point interconnects 952 and 954 through the respective P-P interfaces 976 to 994 and 986 to 998 as shown. For at least one embodiment, the CL 972, 982 may include integrated memory controller units. CLs 972, 982 may include I/O control logic. As depicted, memories 932, 934 coupled to CLs 972, 982 and I/O devices 914 are also coupled to the control logic 972, 982. Legacy I/O devices 915 are coupled to the chipset 990 via interface 996.

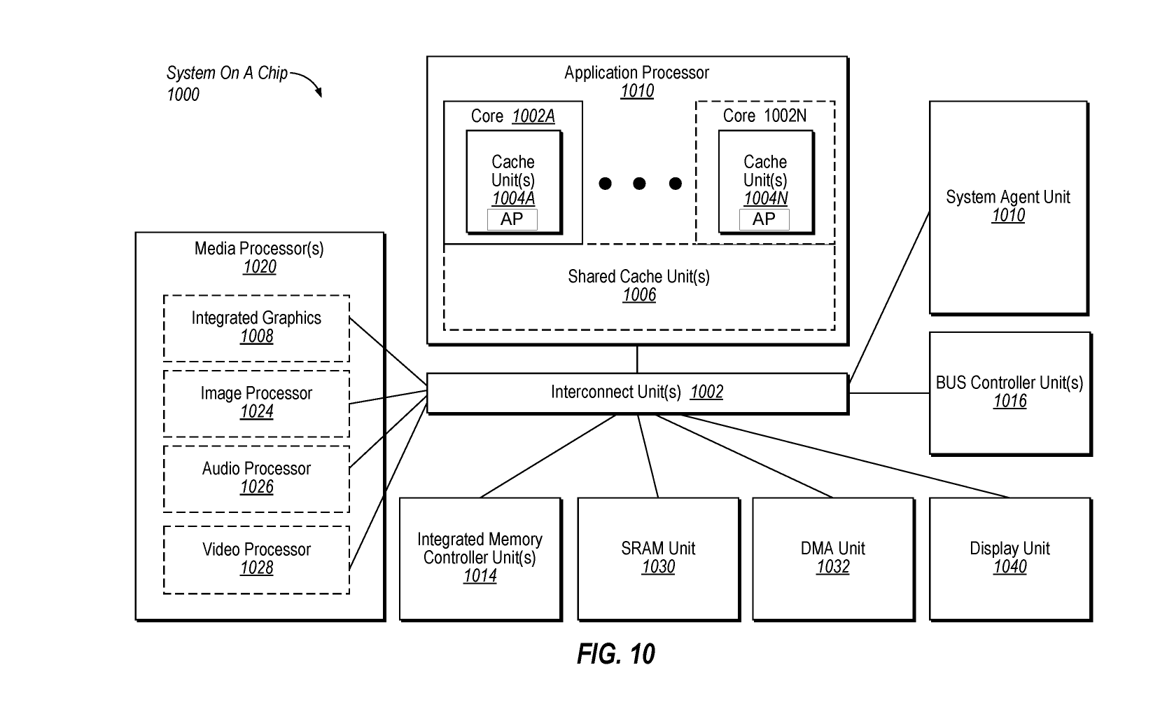

Embodiments may be implemented in many different system types. FIG. 10 is a block diagram of a SoC 1000 in accordance with an embodiment of the present disclosure. Dashed lined boxes are optional features on more advanced SoCs. In some implementations, SoC 1000 as shown in FIG. 10 includes features of the SoC 100 as shown in FIG. 1. In FIG. 10, an interconnect unit(s) 1012 is coupled to: an application processor 1020 which includes a set of one or more cores 1002A-N and shared cache unit(s) 1006; a system agent unit 1010; a bus controller unit(s) 1016; an integrated memory controller unit(s) 1014; a set or one or more media processors 1018 which may include integrated graphics logic 1008, an image processor 1024 for providing still and/or video camera functionality, an audio processor 1026 for providing hardware audio acceleration, and a video processor 1028 for providing video encode/decode acceleration; an static random access memory (SRAM) unit 1030; a direct memory access (DMA) unit 1032; and a display unit 1040 for coupling to one or more external displays. In one embodiment, a memory module may be included in the integrated memory controller unit(s) 1014. In another embodiment, the memory module may be included in one or more other components of the SoC 1000 that may be used to access and/or control a memory. The application processor 1020 may include a store address predictor for implementing hybrid cores as described in embodiments herein.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture and/or instruction set. For example, some of the cores 1002A-N may be in order while others are out-of-order. As another example, two or more of the cores 1002A-N may be capable of execution the same instruction set, while others may be capable of executing only a subset of that instruction set or a different instruction set.

The application processor 1020 may be a general-purpose processor, such as a Core™ i3, i5, i7, 2 Duo and Quad, Xeon™, Itanium™, Atom™ or Quark™ processor, which are available from Intel™ Corporation, of Santa Clara, Calif. Alternatively, the application processor 1020 may be from another company, such as ARM Holdings™, Ltd, MIPS™, etc. The application processor 1020 may be a special-purpose processor, such as, for example, a network or communication processor, compression engine, graphics processor, co-processor, embedded processor, or the like. The application processor 1020 may be implemented on one or more chips. The application processor 1020 may be a part of and/or may be implemented on one or more substrates using any of a number of process technologies, such as, for example, BiCMOS, CMOS, or NMOS.

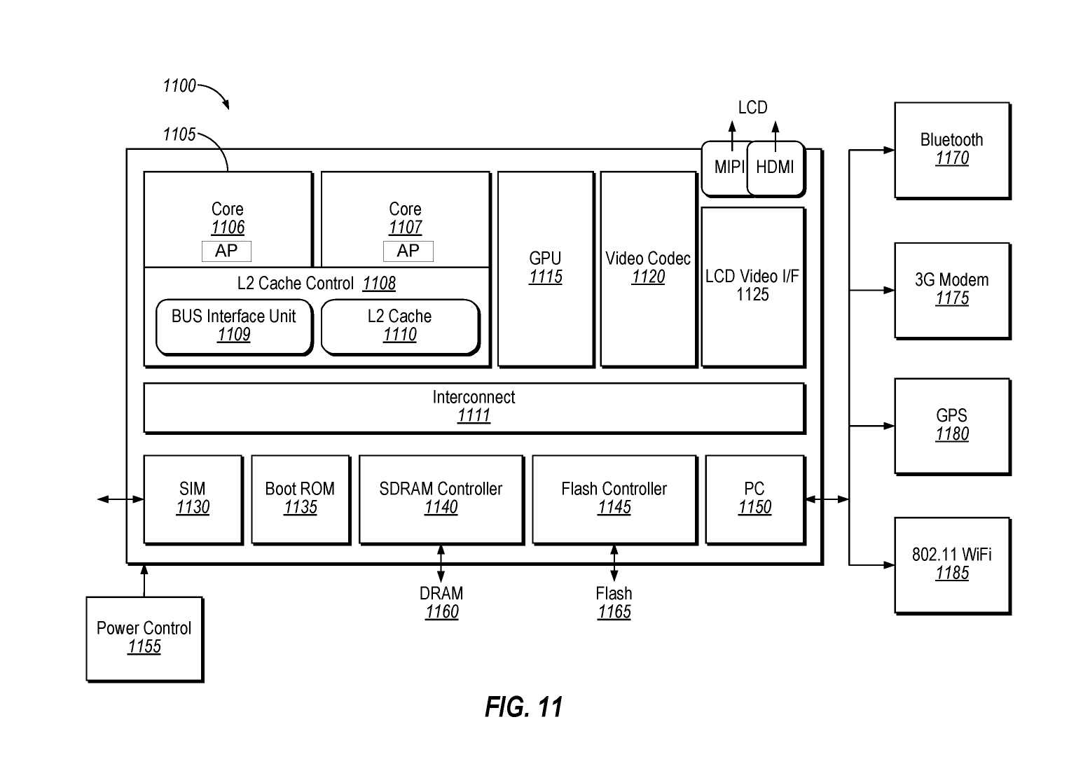

FIG. 11 is a block diagram of an embodiment of a system on-chip (SoC) design in accordance with the present disclosure. As a specific illustrative example, SoC 1100 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1100 includes 2 cores—1106 and 1107. Cores 1106 and 1107 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1106 and 1107 are coupled to cache control 1108 that is associated with bus interface unit 1109 and L2 cache 1110 to communicate with other parts of system 1100. Interconnect 1110 includes an on-chip interconnect, such as an IOSF, AMBA, or other interconnect discussed above, which potentially implements one or more aspects of the described disclosure. In one embodiment, cores 1106, 1107 may implement hybrid cores as described in embodiments herein.

Interconnect 1110 provides communication channels to the other components, such as a Subscriber Identity Module (SIM) 1130 to interface with a SIM card, a boot ROM 1135 to hold boot code for execution by cores 1106 and 1107 to initialize and boot SoC 1100, a SDRAM controller 1140 to interface with external memory (e.g. DRAM 1160), a flash controller 1145 to interface with non-volatile memory (e.g. Flash 1165), a peripheral control 1150 (e.g. Serial Peripheral Interface) to interface with peripherals, video codecs 1120 and Video interface 1125 to display and receive input (e.g. touch enabled input), GPU 1115 to perform graphics related computations, etc. Any of these interfaces may incorporate aspects of the disclosure described herein. In addition, the system 1100 illustrates peripherals for communication, such as a Bluetooth module 1170, 3G modem 1175, GPS 1180, and Wi-Fi 1185.

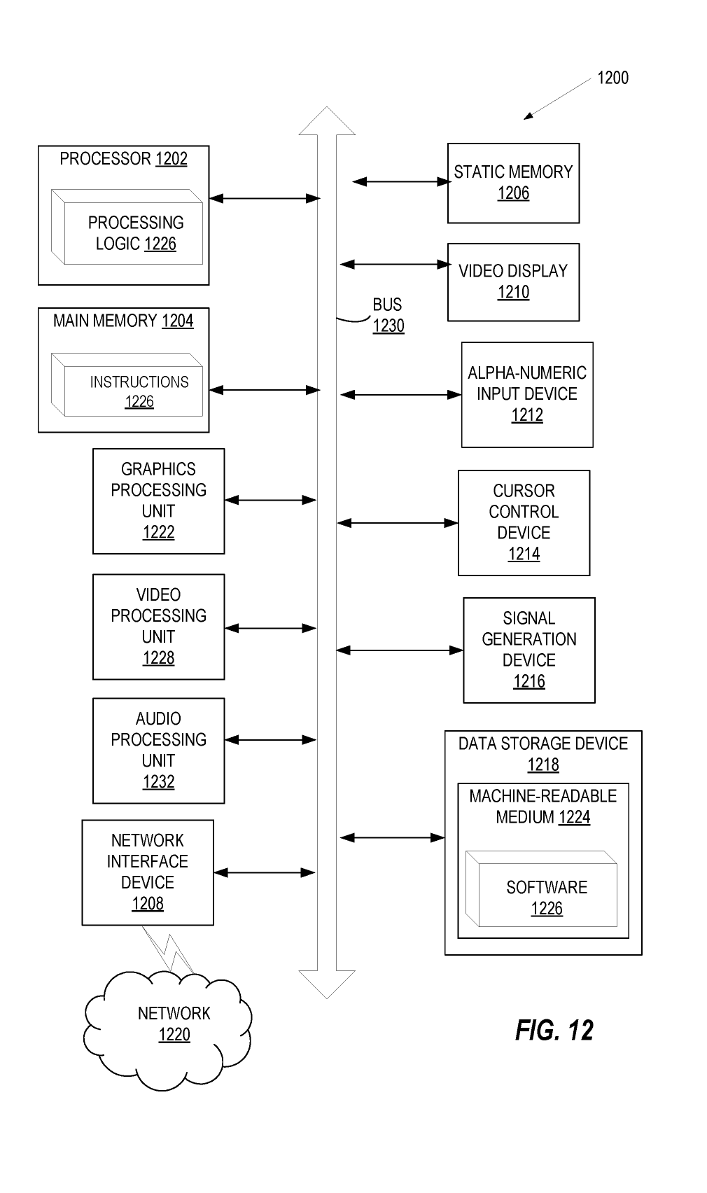

FIG. 12 illustrates a diagrammatic representation of a machine in the example form of a computer system 1200 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1200 includes a processing device 1202, a main memory 1204 (e.g., read-only memory (ROM), flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1218, which communicate with each other via a bus 1230.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. In one embodiment, processing device 1202 may include one or more processing cores. The processing device 1202 is configured to execute the processing logic 1226 for performing the operations and steps discussed herein. For example, processing logic 1226 may perform operations as described in FIG. 4. In one embodiment, processing device 1202 is the same as processor architecture 102 described with respect to FIG. 1 as described herein with embodiments of the disclosure.

The computer system 1200 may further include a network interface device 1208 communicably coupled to a network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker). Furthermore, computer system 1200 may include a graphics processing unit 1222, a video processing unit 1228, and an audio processing unit 1232.

The data storage device 1218 may include a machine-accessible storage medium 1224 on which is stored software 1226 implementing any one or more of the methodologies of functions described herein, such as implementing store address prediction for memory disambiguation as described above. The software 1226 may also reside, completely or at least partially, within the main memory 1204 as instructions 1226 and/or within the processing device 1202 as processing logic 1226 during execution thereof by the computer system 1200; the main memory 1204 and the processing device 1202 also constituting machine-accessible storage media.

The machine-readable storage medium 1224 may also be used to store instructions 1226 implementing store address prediction for hybrid cores such as described according to embodiments of the disclosure. While the machine-accessible storage medium 1128 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present disclosure. The term “machine-accessible storage medium” shall accordingly be taken to include, but not be limited to, solid-state memories, and optical and magnetic media.

The following examples pertain to further embodiments. Example 1 is a processor including a binary translator circuit to convert an instruction stream into an annotated instruction stream comprising an independent code tag identifying an independent code segment and a dependent code tag identifying a dependent code segment, wherein execution of the dependent code segment depends on a result of execution of the independent code segment, a front end circuit to receive the annotated instruction stream in order, responsive to identifying the independent code tag in the annotated instruction stream, allocate instructions of the independent code segment associated with the independent code tag into a buffer, and responsive to identifying the dependent code tag, reserve a space for the dependent code segment associated with the dependent code tag, and an instruction execution circuit to execute the independent code segment prior to executing the dependent code segment.

In Example 2, the subject matter of Example 1 can further provide that the independent code tag comprises a beginning tag indicating a start instruction of the independent code segment and an end tag indicating a last instruction of the independent code segment, and wherein executing the independent code segment produces a value to be evaluated by a conditional instruction determining execution of the dependent code segment.

In Example 3, the subject matter of any of Examples 2 and 3 can further provide that the front end circuit is to responsive to identifying the beginning tag, sequentially allocate the instructions of the the independent code segment into the buffer, and responsive to identifying the end tag, store a position value associated with the last instruction of the independent code segment in a first-in-first-out (FIFO) queue.

In Example 4, the subject matter of Example 1 can further provide that the buffer comprises a list of positions for allocating instructions, and wherein the front end circuit is to responsive to identifying the dependent code tag, determine a length of the dependent code segment, and reserve the space in the list, wherein the space comprises a number of positions corresponding to the length.

In Example 5, the subject matter of Example 1 can further provide that the space is reserved for later allocation of instructions of the dependent code segment.

In Example 6, the subject matter of Example 1 can further provide that the front end circuit is to responsive to executing the independent code segment to produce a value, evaluate a conditional instruction determining execution of the dependent code segment, retrieve from a FIFO to determine a beginning position of the dependent code segment, allocate, based on the value and the beginning position of the dependent code segment, instructions of the dependent code segment in the space reserved for the dependent code segment, and execute the instructions of the dependent code segment.

In Example 7, the subject matter of any of Examples 1 and 6 can further provide that the front end circuit is to determining, based on the value, a number of instructions of the dependent code segment to be executed, and responsive to determining that the number is smaller than the maximum length, storing a position value associated with an instruction following the dependent code segment in a second FIFO.

In Example 8, the subject matter of any of Examples 1 and 6 can further include an instruction retirement circuit to responsive to executing allocated instructions of the independent code segment, retire physical registers associated with the allocated instructions of the independent code segment, responsive to executing allocated instructions of the dependent code segment, retire physical registers associated with the allocated instructions of the dependent code segment, and responsive to retiring the physical registers of a last allocated instruction of the dependent code segment, retrieve from a second FIFO to determine a next allocated instruction and retire physical registers of the next allocated instruction.

In Example 9, the subject matter of Example 1 can further provide that the buffer is at least one of a re-order buffer or a load/store buffer associated with the processor.

Example 10 is a system comprising a memory and a processor, communicatively coupled to the memory, comprising a binary translator circuit to convert an instruction stream into an annotated instruction stream comprising an independent code tag identifying an independent code segment and a dependent code tag identifying a dependent code segment, a front end circuit to receive the annotated instruction stream in order, responsive to identifying the independent code tag in the annotated instruction stream, allocate instructions of the independent code segment associated with the independent code tag into a buffer, and responsive to identifying the dependent code tag, reserve a space for the dependent code segment associated with the dependent code tag, and an instruction execution circuit to execute the independent code segment prior to executing the dependent code segment.

In Example 11, the subject matter of Example 10 can further provide that the independent code tag comprises a beginning tag indicating a start instruction of the independent code segment and an end tag indicating a last instruction of the independent code segment, and wherein executing the independent code segment produces a value to be evaluated by a conditional instruction determining execution of the dependent code segment.

In Example 12, the subject matter of any of Examples 10 and 11 can further provide that the front end circuit is to responsive to identifying the beginning tag, sequentially allocate the instructions of the the independent code segment into the buffer, and responsive to identifying the end tag, store a position value associated with the last instruction of the independent code segment in a first-in-first-out (FIFO) queue.

In Example 13, the subject matter of Example 10 can further provide that the buffer comprises a list of positions for allocating instructions, and wherein the front end circuit is to responsive to identifying the dependent code tag, determine a length of the dependent code segment, and reserve the space in the list, wherein the space comprises a number of positions corresponding to the length.

In Example 14, the subject matter of Example 10 can further provide that the space is reserved for later allocation of instructions of the dependent code segment.

In Example 15, the subject matter of Example 10 can further provide that the front end circuit is to responsive to executing the independent code segment to produce a value, evaluate a conditional instruction determining execution of the dependent code segment, retrieve from a FIFO queue to determine a beginning position of the dependent code segment, allocate, based on the value and the beginning position of the dependent code segment, instructions of the dependent code segment in the space reserved for the dependent code segment, and execute the instructions of the dependent code segment.

In Example 16, the subject matter of any of Examples 10 and 15 can further provide that the front end circuit is to determine, based on the value, a number of instructions of the dependent code segment to be executed, and responsive to determining that the number is smaller than the maximum length, store a position value associated with an instruction following the dependent code segment in a second FIFO queue.

In Example 17, the subject matter of any of Examples 10 and 15 can further include an instruction retirement circuit to responsive to executing allocated instructions of the independent code segment, retire physical registers associated with the allocated instructions of the independent code segment, responsive to executing allocated instructions of the dependent code segment, retire physical registers associated with the allocated instructions of the dependent code segment, and responsive to retiring the physical registers of a last allocated instruction of the dependent code segment, retrieve from a second FIFO queue to determine a next allocated instruction and retire physical registers of the next allocated instruction.

In Example 18, the subject matter of Example 10 can further provide that the buffer is at least one of a re-order buffer or a load/store buffer associated with the processor.

Example 19 is a method comprising converting, by a binary translator of a processor, an instruction stream into an annotated instruction stream comprising an independent code tag identifying an independent code segment and a dependent code tag identifying a dependent code segment, wherein execution of the dependent code segment depends on a result of execution of the independent code segment, responsive to identifying the independent code tag in the annotated instruction stream, allocating, by the processor, instructions of the independent code segment associated with the independent code tag into a buffer, responsive to identifying the dependent code tag, reserving, by the processor, a space for the dependent code segment associated with the dependent code tag, and executing, by the processor, the independent code segment prior to executing the dependent code segment.

In Example 20, the subject matter of Example 19 can further include responsive to executing the independent code segment, determining the result on which the dependent code segment depends, retrieving from a FIFO queue to determine a beginning position of the dependent code segment, allocating, based on the result and the beginning position of the dependent code segment, instructions of the dependent code segment in the space reserved for the dependent code segment, and executing the instructions of the dependent code segment.

Example 21 is an apparatus comprising: means for performing the method of any of Examples 19 to 20.

Example 22 is a machine-readable non-transitory medium having stored thereon program code that, when executed, perform operations comprising converting, by a binary translator of a processor, an instruction stream into an annotated instruction stream comprising an independent code tag identifying an independent code segment and a dependent code tag identifying a dependent code segment, wherein execution of the dependent code segment depends on a result of execution of the independent code segment, responsive to identifying the independent code tag in the annotated instruction stream, allocating, by the processor, instructions of the independent code segment associated with the independent code tag into a buffer, responsive to identifying the dependent code tag, reserving, by the processor, a space for the dependent code segment associated with the dependent code tag, and executing, by the processor, the independent code segment prior to executing the dependent code segment.

In Example 23, the subject matter of Example 22 can further include responsive to executing the independent code segment, determining the result on which the dependent code segment depends, retrieving from a FIFO queue to determine a beginning position of the dependent code segment, allocating, based on the result and the beginning position of the dependent code segment, instructions of the dependent code segment in the space reserved for the dependent code segment, and executing the instructions of the dependent code segment.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and/or ‘operable to,’ in one embodiment, refers to some apparatus, logic, hardware, and/or element designed in such a way to enable use of the apparatus, logic, hardware, and/or element in a specified manner Note as above that use of ‘to,’ ‘capable of/to,’ and/or ‘operable to,’ in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A processor, comprising:
a binary translator circuit to convert an instruction stream into an annotated instruction stream comprising an independent code tag identifying an independent code segment and a dependent code tag identifying a dependent code segment;
a front end circuit to:
receive the annotated instruction stream in order;
responsive to identifying the independent code tag in the annotated instruction stream, allocate instructions of the independent code segment associated with the independent code tag into a buffer; and
responsive to identifying the dependent code tag, reserve a space for the dependent code segment associated with the dependent code tag; and
an instruction execution circuit to execute the independent code segment prior to executing the dependent code segment.

2. The processor of claim 1, wherein the independent code tag comprises a beginning tag indicating a start instruction of the independent code segment and an end tag indicating a last instruction of the independent code segment, and wherein executing the independent code segment produces a value to be evaluated by a conditional instruction determining execution of the dependent code segment.

3. The processor of claim 2, wherein the front end circuit is to:
responsive to identifying the beginning tag, sequentially allocate the instructions of the the independent code segment into the buffer; and
responsive to identifying the end tag, store a position value associated with the last instruction of the independent code segment in a first-in-first-out (FIFO) queue.

4. The processor of claim 1, wherein the buffer comprises a list of positions for allocating instructions, and wherein the front end circuit is to:
responsive to identifying the dependent code tag, determine a length of the dependent code segment; and
reserve the space in the list, wherein the space comprises a number of positions corresponding to the length.

5. The processor of claim 1, wherein the space is reserved for later allocation of instructions of the dependent code segment.

6. The processor of claim 1, wherein the front end circuit is to:
responsive to executing the independent code segment to produce a value, evaluate a conditional instruction determining execution of the dependent code segment;
retrieve from a FIFO to determine a beginning position of the dependent code segment;
allocate, based on the value and the beginning position of the dependent code segment, instructions of the dependent code segment in the space reserved for the dependent code segment; and
execute the instructions of the dependent code segment.

7. The processor of claim 6, wherein the front end circuit is to:
determine, based on the value, a number of instructions of the dependent code segment to be executed; and
responsive to determining that the number is smaller than the maximum length, store a position value associated with an instruction following the dependent code segment in a second FIFO.

8. The processor of claim 6, further comprising an instruction retirement circuit to:
responsive to executing allocated instructions of the independent code segment, retire physical registers associated with the allocated instructions of the independent code segment;
responsive to executing allocated instructions of the dependent code segment, retire physical registers associated with the allocated instructions of the dependent code segment; and
responsive to retiring the physical registers of a last allocated instruction of the dependent code segment, retrieve from a second FIFO to determine a next allocated instruction and retire physical registers of the next allocated instruction.

9. The processor of claim 1, wherein the buffer is at least one of a re-order buffer or a load/store buffer associated with the processor.

10. A system comprising:
a memory; and
a processor, communicatively coupled to the memory, comprising:
a binary translator circuit to convert an instruction stream into an annotated instruction stream comprising an independent code tag identifying an independent code segment and a dependent code tag identifying a dependent code segment;
a front end circuit to:
receive the annotated instruction stream in order;
responsive to identifying the independent code tag in the annotated instruction stream, allocate instructions of the independent code segment associated with the independent code tag into a buffer; and
responsive to identifying the dependent code tag, reserve a space for the dependent code segment associated with the dependent code tag; and
an instruction execution circuit to execute the independent code segment prior to executing the dependent code segment.

11. The system of claim 10, wherein the independent code tag comprises a beginning tag indicating a start instruction of the independent code segment and an end tag indicating a last instruction of the independent code segment, and wherein executing the independent code segment produces a value to be evaluated by a conditional instruction determining execution of the dependent code segment.

12. The system of claim 11, wherein the front end circuit is to:
responsive to identifying the beginning tag, sequentially allocate the instructions of the the independent code segment into the buffer; and
responsive to identifying the end tag, store a position value associated with the last instruction of the independent code segment in a first-in-first-out (FIFO) queue.

13. The system of claim 10, wherein the buffer comprises a list of positions for allocating instructions, and wherein the front end circuit is to:
responsive to identifying the dependent code tag, determine a length of the dependent code segment; and
reserve the space in the list, wherein the space comprises a number of positions corresponding to the length.

14. The system of claim 10, wherein the space is reserved for later allocation of instructions of the dependent code segment.

15. The system of claim 10, wherein the front end circuit is to:
responsive to executing the independent code segment to produce a value, evaluate a conditional instruction determining execution of the dependent code segment;
retrieve from a FIFO queue to determine a beginning position of the dependent code segment;
allocate, based on the value and the beginning position of the dependent code segment, instructions of the dependent code segment in the space reserved for the dependent code segment; and
execute the instructions of the dependent code segment.

16. The system of claim 15, wherein the front end circuit is to:
determine, based on the value, a number of instructions of the dependent code segment to be executed; and
responsive to determining that the number is smaller than the maximum length, store a position value associated with an instruction following the dependent code segment in a second FIFO queue.

17. The system of claim 15, further comprising an instruction retirement circuit to:
responsive to executing allocated instructions of the independent code segment, retire physical registers associated with the allocated instructions of the independent code segment;
responsive to executing allocated instructions of the dependent code segment, retire physical registers associated with the allocated instructions of the dependent code segment; and
responsive to retiring the physical registers of a last allocated instruction of the dependent code segment, retrieve from a second FIFO queue to determine a next allocated instruction and retire physical registers of the next allocated instruction.

18. The system of claim 10, wherein the buffer is at least one of a re-order buffer or a load/store buffer associated with the processor.

19. A method comprising:
converting, by a binary translator of a processor, an instruction stream into an annotated instruction stream comprising an independent code tag identifying an independent code segment and a dependent code tag identifying a dependent code segment, wherein execution of the dependent code segment depends on a result of execution of the independent code segment;
responsive to identifying the independent code tag in the annotated instruction stream, allocating, by the processor, instructions of the independent code segment associated with the independent code tag into a buffer;
responsive to identifying the dependent code tag, reserving, by the processor, a space for the dependent code segment associated with the dependent code tag; and
executing, by the processor, the independent code segment prior to executing the dependent code segment.

20. The method of claim 19, further comprising:
responsive to executing the independent code segment, determining the result on which the dependent code segment depends;
retrieving from a FIFO queue to determine a beginning position of the dependent code segment;
allocating, based on the result and the beginning position of the dependent code segment, instructions of the dependent code segment in the space reserved for the dependent code segment; and
executing the instructions of the dependent code segment.
